(19) United States
(12) Patent Application Publication
(10) Pub. No.: US 2022/0084314 A1
(43) Pub. Date: Mar. 17, 2022

(54) METHOD FOR OBTAINING MULTI-DIMENSIONAL INFORMATION BY PICTURE-BASED INTEGRATION AND RELATED DEVICE

(71) Applicant: SHENZHEN SENSETIME TECHNOLOGY CO., LTD., Shenzhen (CN)

(72) Inventors: Xiaoying HUANG, Shenzhen (CN); Hao FU, Shenzhen (CN); Guiming ZHANG, Shenzhen (CN); Min ZHANG, Shenzhen (CN); Huixuan GAO, Shenzhen (CN)

(21) Appl. No.: 17/536,774

(22) Filed: Nov. 29, 2021

Related U.S. Application Data
(63) Continuation of application No. PCT/CN2020/100268, filed on Jul. 3, 2020.

(30) Foreign Application Priority Data
Dec. 30, 2019 (CN) 201911402864.5

(51) Int. Cl. G06V 20/52; G06V 40/16; G06F 16/583

(52) U.S. Cl. CPC G06V 20/52; G06F 16/583; G06V 40/171; G06V 40/165

(57) ABSTRACT

The disclosure provides a method for obtaining multi-dimensional information by picture-based integration and a related device. The method includes the following operations. A to-be-detected picture is acquired. The to-be-detected picture is detected and multiple pieces of feature information are extracted from the to-be-detected picture. Target feature information and associated feature information are selected from the multiple pieces of feature information, and the target feature information is associated to the associated feature information to generate multi-dimensional information. The multi-dimensional information includes multiple pieces of feature information associated with each other.

### CROSS-REFERENCE TO RELATED APPLICATION

The application is a continuation of International Application No. PCT/CN2020/100268, filed on Jul. 3, 2020, which claims priority to Chinese Patent Application No. 201911402864.5, filed to the Chinese Patent Office on Dec. 30, 2019 and entitled” METHOD FOR OBTAINING MULTI-DIMENSIONAL INFORMATION BY PICTURE-BASED INTEGRATION AND RELATED DEVICE”. The entire contents of International Application No. PCT/CN2020/100268 and Chinese Patent Application No. 201911402864.5 are incorporated herein by reference.

### BACKGROUND

Many point locations have been established for cameras in cities at present to capture real-time videos containing various information such as human bodies, human faces, motor vehicles and non-motor vehicles. When the police department carries out daily tasks such as case solving, video investigation and suspect tracking, pictures with a suspect's information (including a human face, a human body, a vehicle used during crimine/escape, etc.) acquired in various channels often need to be uploaded, and then compared with information in these videos, so as to collect various clues, supplement evidence chains, improve the suspect's action routes and escaping tracks, etc., through the retrieval result.

### SUMMARY

The disclosure relates to the technical field of intelligent devices, in particular to a method for obtaining multi-dimensional information by picture-based integration and a related device.

In one aspect, a first technical solution in the disclosure is to provide a method for obtaining multi-dimensional information by picture-based integration, including: acquiring a to-be-detected picture; detecting the to-be-detected picture and extracting a plurality of pieces of feature information from the to-be-detected picture; and selecting, from the plurality of pieces of feature information, target feature information and associated feature information, and associating the target feature information to the associated feature information to generate multi-dimensional information, wherein the multi-dimensional information includes a plurality of pieces of feature information associated with each other.

In another aspect, the disclosure provides an apparatus for obtaining multi-dimensional information by picture-based integration, including: an acquisition module, configured to acquire a to-be-detected picture; a feature extraction module, configured to detect the to-be-detected picture and extract a plurality of pieces of feature information from the to-be-detected picture; and a feature association module, configured to select, from the plurality of pieces of feature information, target feature information and associated feature information, and associate the target feature information to the associated feature information to generate multi-dimensional information, wherein the multi-dimensional information includes a plurality of pieces of feature information associated with each other.

In another aspect, the disclosure provides a device for obtaining multi-dimensional information by picture-based integration, including a memory and a processor. The memory has program instructions stored thereon, and the processor calls the program instructions from the memory to: acquire a to-be-detected picture; detect the to-be-detected picture and extract a plurality of pieces of feature information from the to-be-detected picture; and select, from the plurality of pieces of feature information, target feature information and associated feature information, and associate the target feature information to the associated feature information to generate multi-dimensional information, wherein the multi-dimensional information includes a plurality of pieces of feature information associated with each other.

In another aspect, the disclosure provides a non-transitory computer-readable storage medium having stored thereon a program file which is executable to implement a method for obtaining multi-dimensional information by picture-based integration, including: acquiring a to-be-detected picture; detecting the to-be-detected picture and extracting a plurality of pieces of feature information from the to-be-detected picture; and selecting, from the plurality of pieces of feature information, target feature information and associated feature information, and associating the target feature information to the associated feature information to generate multi-dimensional information, wherein the multi-dimensional information includes a plurality of pieces of feature information associated with each other.

In yet another aspect, the disclosure also provides a computer program in which instructions, when being executed by a processor, causes the processor to perform any above method for obtaining multi-dimensional information by picture-based integration.

### BRIEF DESCRIPTION OF THE DRAWINGS

FIG. 1 illustrates a schematic flowchart of a first embodiment of a method for obtaining multi-dimensional information by picture-based integration according to the disclosure.

FIG. 2 illustrates a schematic flowchart of a particular embodiment of step S12 of FIG. 1.

FIG. 3 illustrates a schematic flowchart of a particular embodiment of step S13 of FIG. 1.

FIG. 4 illustrates a schematic flowchart of another embodiment of step S13 of FIG. 1.

FIG. 5 illustrates a schematic structural diagram of a second embodiment of the method for obtaining multi-dimensional information by picture-based integration according to the disclosure.

FIG. 6 illustrates a schematic structural diagram of a third embodiment of the method for obtaining multi-dimensional information by picture-based integration according to the disclosure.

FIG. 7 illustrates a schematic structural diagram of a first embodiment of an apparatus for obtaining multi-dimensional information by picture-based integration according to the disclosure.

FIG. 8 illustrates another schematic structural diagram of the first embodiment of the apparatus for obtaining multi-dimensional information by picture-based integration according to the disclosure.

FIG. 9 illustrates a schematic structural diagram of a second embodiment of the device for obtaining multi-dimensional information by picture-based integration according to the disclosure.

FIG. 10 illustrates a schematic structural diagram of a computer-readable storage medium according to the disclosure.

### DETAILED DESCRIPTION

In the following, the technical solutions in the embodiments of the disclosure will be clearly and completely described below in conjunction with the accompanying drawings in the embodiments of the disclosure. It will be apparent that the described embodiments are only part of the embodiments of the disclosure but not all of the embodiments. Based on the embodiments in the disclosure, all the other embodiments obtained by those of ordinary skill in the art without paying any creative work shall fall within the protection scope of the disclosure.

In the related art, multiple features are recognized and extracted from the same picture one by one, resulting in a complex process. It is difficult to associate the multiple features with each other, and the accuracy of association is low. Therefore, the disclosure provides a particular method for obtaining multi-dimensional information by picture-based integration. With the development of human face retrieval, human body retrieval and vehicle retrieval, the method provided in the disclosure can recognize and extract human faces, human bodies and vehicles from the same picture simultaneously, and associate the human faces, human bodies and vehicles automatically according to their position relationships with each other, to obtain the associated multi-dimensional information.

An advantageous effect of the disclosure over the related art is that: a to-be-detected picture is acquired, the to-be-detected picture is detected and multiple pieces of feature information are extracted from the to-be-detected picture; and target feature information and associated feature information are selected from the multiple pieces of feature information, and the target feature information is associated to the associated feature information to generate multi-dimensional information. The multi-dimensional information includes multiple pieces of feature information associated with each other. Therefore, automatic extraction, and automatic association of multiple pieces of feature information in the picture are achieved.

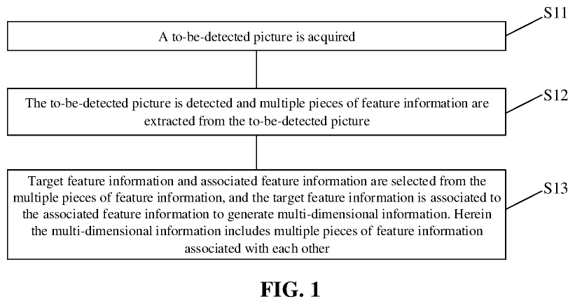

Specifically, referring to FIG. 1 which illustrates a schematic flowchart of a first embodiment of a method for obtaining multi-dimensional information by picture-based integration according to the disclosure.

The method for obtaining multi-dimensional information by picture-based integration according to the disclosure may be applied to an apparatus for obtaining multi-dimensional information by picture-based integration. The apparatus for obtaining multi-dimensional information by picture-based integration may be a terminal device such as a smartphone, a tablet computer, a notebook computer, a computer, or a wearable device, etc., or may be a monitoring system in a traffic block port system. Throughout the following descriptions of the embodiments, the method for obtaining multi-dimensional information by picture-based integration is described from the perspective of the apparatus for obtaining multi-dimensional information by picture-based integration. Specifically, the method for obtaining multi-dimensional information by picture-based integration as illustrated in FIG. 1 includes the following operations.

In operation S11: a to-be-detected picture is acquired.

Specifically, the to-be-detected picture may include one or more to-be-detected pictures. The to-be-detected picture may be a picture containing any of: a human face, a human body, and a vehicle. Specifically, the to-be-detected picture may contain one or more human faces, one or more human bodies, and one or more vehicles, which is not specifically limited.

In operation S12: the to-be-detected picture is detected and multiple pieces of feature information are extracted from the to-be-detected picture.

Specifically, the operation of extracting the multiple pieces of feature information from the to-be-detected picture includes extracting at least two of the following from the to-be-detected picture: human face feature information, human body feature information, or vehicle feature information. For example, in an embodiment, the human face feature information and the human body feature information may be extracted from the to-be-detected picture. Alternatively, the human body feature information and the vehicle feature information may be extracted from the to-be-detected picture. Alternatively, the human face feature information and the vehicle feature information may be extracted from the to-be-detected picture. Alternatively, the human face feature information, the human body feature information, and the vehicle feature information may be extracted from the to-be-detected picture.

In operation S13: target feature information and associated feature information are selected from the multiple pieces of feature information, and the target feature information is associated to the associated feature information to generate multi-dimensional information. Herein the multi-dimensional information includes multiple pieces of feature information associated with each other.

Specifically, after obtaining the multiple pieces of feature information (the human face feature information, the human body feature information, and the vehicle feature information) from the to-be-detected picture by detection, one of the multiple pieces of feature information may be taken as the target feature information, and the remaining of the multiple pieces of feature information may be taken as the associated feature information. The target feature information is associated to the associated feature information according to the position relationship to form the multi-dimensional information. Specifically, the multi-dimensional information may include multiple pieces of feature information associated with each other.

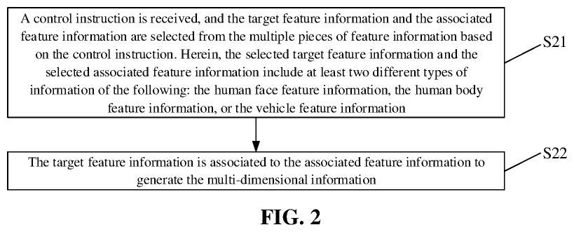

In a particular embodiment, S13 may be performed through the method as illustrated in FIG. 2. Specifically, the method includes the following operations.

In operation S21: a control instruction is received, and the target feature information and the associated feature information are selected from the multiple pieces of feature information based on the control instruction. Herein, the selected target feature information and the selected associated feature information include at least two different types of information of the following: the human face feature information, the human body feature information, or the vehicle feature information.

In a particular embodiment, in order to further improve the accuracy of tracking, the target feature information may also include two different types of feature information in the embodiment. For example, the selected target feature information may include both human face feature information and human body feature information, or may include both human face feature information and vehicle feature information, or may include both human body feature information and vehicle feature information.

In operation S22: the target feature information is associated to the associated feature information to generate the multi-dimensional information.

The selected target feature information is integrated and associated to the associated feature information according to a position relationship to form the multi-dimensional information.

According to the method for obtaining multi-dimensional information by integration in the embodiment, multiple pieces of feature information can be recognized simultaneously. Moreover, by selecting target feature information and associated feature information from the multiple pieces of feature information, and further integrating the target feature information with the associated feature information to form the multi-dimensional information, associated features associated with different target features can be determined through the target features, so as to achieve automatic association. Furthermore, the accuracy of association is improved through association from different perspectives.

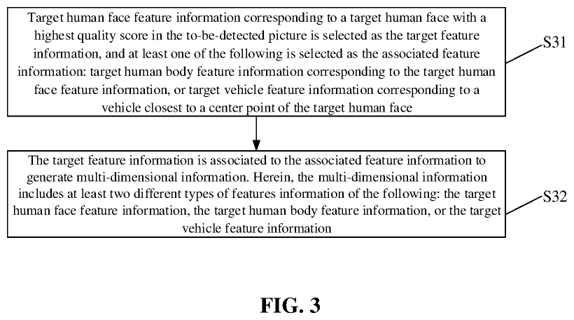

In an implementation, as illustrated in FIG. 3, the operation S13 includes the following sub-operations.

In sub-operation S31: target human face feature information corresponding to a target human face with a highest quality score in the to-be-detected picture is selected as the target feature information, and at least one of the following is selected as the associated feature information: target human body feature information corresponding to the target human face feature information, or target vehicle feature information corresponding to a vehicle closest to a center point of the target human face.

After performing feature extraction on the to-be-detected picture, the human face feature information, the human body feature information and the vehicle feature information are extracted from the to-be-detected picture. The extracted target human face feature information with the highest quality score is used as the target feature information, and human body feature information containing the human face feature information of the target human face and target vehicle feature information corresponding to a vehicle closest to the center point of the target human face are used as the associated feature information. Then the selected human face feature information, the human body feature information, and the vehicle feature information are associated to each other.

In sub-operation S32: the target feature information is associated to the associated feature information to generate multi-dimensional information. Herein, the multi-dimensional information includes at least two different types of features information of the following: the target human face feature information, the target human body feature information, or the target vehicle feature information.

Specifically, when the target feature information is associated to the associated feature information to form the multi-dimensional information, if the target feature information includes one type of feature information and the associated feature information also includes one type of feature information, the multi-dimensional information includes two different types of feature information. For example, if the target feature information includes human face feature information and the associated feature information includes human body feature information, the multi-dimensional information includes two different types of feature information: the human face feature information and the human body feature information. For another example, if the target feature information includes one type of feature information and the associated feature information includes two different types of feature information, the multi-dimensional information includes three different types of feature information. For example, if the target feature information includes human face feature information and the associated feature information includes human body feature information and vehicle feature information, the multi-dimensional information includes three different types of feature information: the human face feature information, the human body feature information, and the vehicle feature information.

According to the method for obtaining multi-dimensional information by integration of the embodiment, the target human face feature information corresponding to the target human face with the highest quality score is selected as the target feature information, and at least one of target human body feature information corresponding to the target human face feature information, or target vehicle feature information corresponding to the vehicle closest to the center point of the target human face is selected as the associated feature information. Herein the human face with the highest quality score is the clearest human face in the to-be-detected picture. Therefore, the accuracy of association can be improved, so as to prevent the case where a human face and a human body without correspondence are associated to each other, or a human face and a vehicle without correspondence are associated to each other.

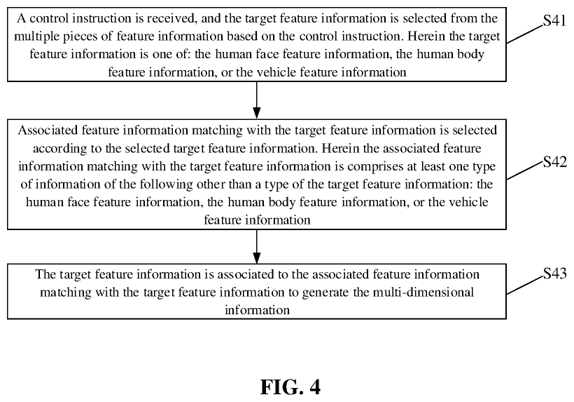

In another implementation, as illustrated in FIG. 4, the operation S13 includes the following sub-operations.

In sub-operation S41: a control instruction is received, and the target feature information is selected from the multiple pieces of feature information based on the control instruction. Herein the target feature information is one of: the human face feature information, the human body feature information, or the vehicle feature information.

Specifically, a piece of feature information may be selected from the feature information obtained by detection as the target feature information, and the remaining feature information may be taken as the associated feature information.

Herein the target feature information may be human face feature information, or may be human body feature information, or may be vehicle feature information, which is not specifically limited.

In sub-operation S42: associated feature information matching with the target feature information is selected according to the selected target feature information. Herein the associated feature information matching with the target feature information includes at least one type of information of the following other than a type of the target feature information: the human face feature information, the human body feature information, or the vehicle feature information.

In a particular embodiment, if the selected target feature information is human face feature information, human body feature information and vehicle feature information matching therewith are selected from the remaining feature information according to the selected human face feature information. If the selected target feature information is human body feature information, human face feature information and vehicle feature information matching therewith are selected from the remaining feature information according to the selected human body feature information. If the selected target feature information is vehicle feature information, human face feature information and human body feature information matching therewith are selected from the remaining feature information according to the selected vehicle feature information.

In sub-operation S43: the target feature information is associated to the associated feature information matching with the target feature information to generate the multi-dimensional information.

The selected target feature information is associated to the associated feature information matching with the target feature information to generate the multi-dimensional information. Specifically, the human face feature information, the human body feature information, and the vehicle feature information are associated to each other to generate the multi-dimensional information including the human face feature information, the human body feature information, and the vehicle feature information.

Specifically, in an embodiment, when the feature information is detected, the coordinate position corresponding to each piece of feature information is acquired at the same time. The target feature information is integrated and associated to the associated feature information according to the coordinate position corresponding to the target feature information and the coordinate position corresponding to the associated feature information. For example, when the human face feature information is detected in the to-be-detected picture, coordinates around the human face feature are acquired to form a bounding box surrounding the human face feature. When the human body feature information is detected in the to-be-detected picture, coordinates around the human body feature are acquired to form a bounding box surrounding the human body feature. When the vehicle feature information is detected in the to-be-detected, coordinates around the vehicle feature are acquired to form a bounding box surrounding the vehicle feature.

In a particular embodiment, in the case where the human face feature information is selected as the target feature information, when the associated feature information matching therewith is selected according to the target feature information (the human face feature information), a bounding box of human body feature information which contains the bounding box of the selected human face feature information is determined. In this case, the human body feature information within the bounding box of human body feature information matches with the human face feature information. A bounding box of vehicle feature information which contains a vehicle closest to the center point of the bounding box of the selected human face feature information is determined. In this case, the vehicle feature information within the bounding box of vehicle feature information matches with the human face feature information. The human face feature information, the human body feature information and the vehicle feature information are associated and integrated to each other according to the coordinate positions of the bounding boxes.

In another particular embodiment, in the case where the human body feature information is selected as the target feature information, when the associated feature information matching therewith is selected according to the target feature information (the human body feature information), it is determined whether the bounding box of the selected human body feature information contains a bounding box of selected human face feature information; if yes, the human face feature information in the bounding box of selected human face feature information matches with the human body feature information. A bounding box of vehicle feature information which contains the vehicle closest to the center point of the bounding box corresponding to the selected human body feature information is determined. In this case, the vehicle feature information within the bounding box of vehicle feature information matches with the human body feature information. The human face feature information, the human body feature information and the vehicle feature information are associated and integrated with each other according to the coordinate positions of the bounding boxes.

In yet another embodiment, in the case where the vehicle feature information is selected as the target feature information, when the associated feature information matching therewith is selected according to the target feature information (the vehicle feature information), a bounding box containing human face feature information and a bounding box containing human face feature information which are closest to the center point of the bounding box of the selected vehicle feature information are determined. Herein the human face feature information within the bounding box containing the human face feature information matches with the vehicle feature information, and the human body feature information within the bounding box containing the human body feature information matches with the vehicle feature information. The human face feature information, the human body feature information and the vehicle feature information are associated and integrated to each other according to the coordinate positions of the bounding boxes.

According to the method for obtaining multi-dimensional information by picture-based integration as described in the embodiment, the associated feature information matching with the target feature information is determined by the positions of the target feature information and the associated feature information, and the target feature information and the associated feature information are integrated and associated to each other. Thus, automatic extraction, and automatic association and integration of multiple pieces of feature information are realized. The labor burden of staffs can be greatly reduced and thus the work efficiency is improved in practical applications.

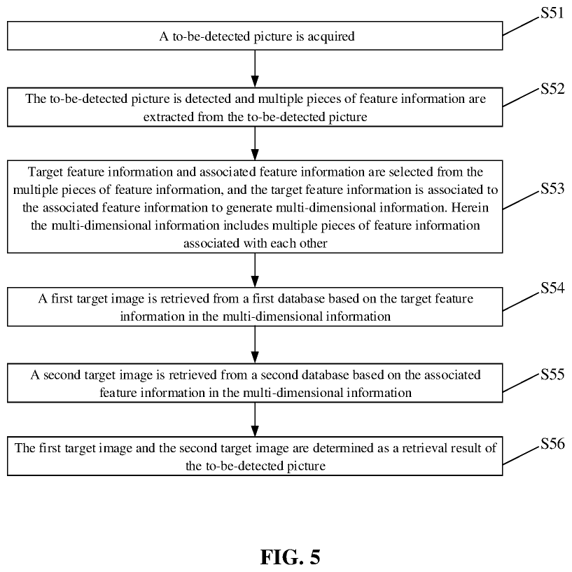

FIG. 5 illustrates a schematic flowchart of a second embodiment of the method for obtaining multi-dimensional information by picture-based integration according to the disclosure.

The embodiment includes operations S51˜S53 which are the same as operations S11˜S13 in FIG. 1, and differs from the first embodiment in that the method further includes the following operations after operation S13.

In operation S54: a first target image is retrieved from a first database based on the target feature information in the multi-dimensional information.

Specifically, after the multi-dimensional information is obtained by synthesis, the multi-dimensional information is input to the first database for retrieval, to acquire the first target image corresponding to the target feature information in the multi-dimensional information. Specifically, in an embodiment, if the target feature information in the multi-dimensional information is human face feature information, the first database is a human face feature database. The human face feature information in the multi-dimensional information is matched with the human face feature database to acquire multiple first target images matching with the human face feature information.

In operation S55: a second target image is retrieved from a second database based on the associated feature information in the multi-dimensional information.

Specifically, in an embodiment, if the associated feature information in the multi-dimensional information is human body feature information, the second database is a human body feature database. The human body feature information in the multi-dimensional information is matched with the human body feature database to acquire multiple second target images matching with the human body feature information. Alternatively, in an embodiment, if the associated feature information in the multi-dimensional information is vehicle feature information, the second database is a vehicle feature database. The vehicle feature information in the multi-dimensional information is matched with the vehicle feature database to acquire multiple second target images matching with the vehicle feature information.

In operation S56: the first target image and the second target image are determined as a retrieval result of the to-be-detected picture.

Specifically, the retrieved first target image and second target image are the retrieval result corresponding to the to-be-detected picture. In an embodiment, if the first target image and the second target image are integrated with each other, the motion trajectory corresponding to at least one of the target feature information or the associated feature information can be acquired according to the photographing locations and the photographing time of the first target image and the second target image. Specifically, this solution may be applied to criminal investigation for search of escape routes of suspects or target persons. When searching for suspects and tracking target persons, the method for obtaining multi-dimensional information by integration in the embodiment can greatly reduce the labor burden of staffs, thereby improving the work efficiency.

Specifically, after the first target image and the second target image are determined as the retrieval result pictures of the to-be-detected picture, other pictures corresponding to the retrieval result pictures may also be searched according to the retrieval result pictures.

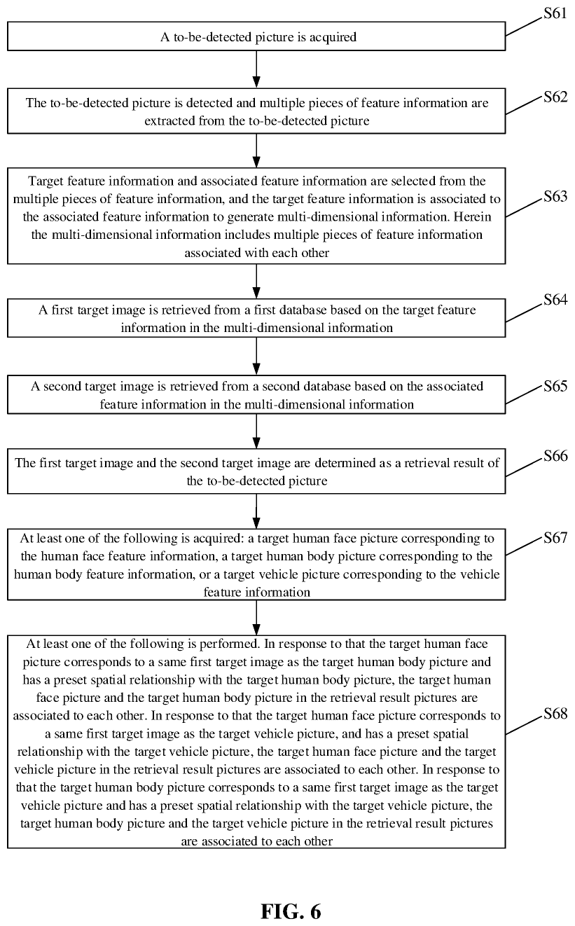

Specifically, please refer to FIG. 6 which illustrates a schematic flowchart of a third embodiment of the method for obtaining multi-dimensional information by picture-based integration according to the disclosure. The third embodiment includes operations S61˜S66 which are the same as operations S51˜S56 in FIG. 5, and differs from the second embodiment in that the method further includes the following operations after operation S56.

In operation S67: at least one of the following is acquired: a target human face picture corresponding to the human face feature information, a target human body picture corresponding to the human body feature information, or a target vehicle picture corresponding to the vehicle feature information.

Specifically, the target human face picture containing the human face feature may be acquired according to the human face feature. Herein the target human face picture may contain the human face feature, the human body feature, and the vehicle feature. The target human body picture containing the human body feature may also be acquired according to the human body feature. Herein the target human body picture may contain the human face feature, the human body feature, and the vehicle feature. The target vehicle picture containing the vehicle feature may also be acquired according to the vehicle feature. Herein, the target vehicle picture may contain the human face feature, the human body feature, and the vehicle feature.

In operation S68: at least one of the following is performed. In response to that the target human face picture corresponds to a same first target image as the target human body picture and has a preset spatial relationship with the target human body picture, the target human face picture and the target human body picture in the retrieval result pictures are associated to each other. In response to that the target human face picture corresponds to a same first target image as the target vehicle picture, and has a preset spatial relationship with the target vehicle picture, the target human face picture and the target vehicle picture in the retrieval result pictures are associated to each other. In response to that the target human body picture corresponds to a same first target image as the target vehicle picture and has a preset spatial relationship with the target vehicle picture, the target human body picture and the target vehicle picture in the retrieval result pictures are associated to each other.

Specifically, the first target image (which may contain a human face and a human body) is acquired. The first target image may include the target human face picture and the target human body picture, one of which is a first target picture, and the the other of which is a second target picture. If the coverage of the first target picture contains the coverage of the second target picture, or the image coverage of the first target picture partially overlaps the image coverage of the second target picture, or the image coverage of the first target picture is connected with the image coverage of the second target picture, the target human face picture and the target human body picture in the retrieval result pictures are associated to each other.

In this case, if a first target image includes only a human face picture and a second target image includes only a human body picture, the human face picture may serve as a target human face picture, and the human body picture may serve as a target human body picture; and the target human face picture may be associated to the target human body picture to obtain a complete associated image. In this way, the human body may be searched through the human face, or the human face may be searched through the human body.

Alternatively, the first target image (which may contain the human face and the vehicle) is acquired. The first target image may include the target human face picture and the target vehicle picture, one of which is a first target picture, and the the other of which is a second target picture. If the coverage of the first target picture contains the coverage of the second target picture, or the image coverage of the first target picture partially overlaps the image coverage of the second target picture, or the image coverage of the first target picture is connected with the image coverage of the second target picture, the target human face picture and the target vehicle picture in the retrieval result pictures are associated to each other.

In this case, if a first target image contains only a human face picture and a second target image contains only a vehicle picture, the human face picture may serve as a target human face picture and the vehicle picture may serve as a target vehicle picture; and the target human face picture may be associated to the target vehicle picture to obtain a complete associated image. In this way, the vehicle may be searched through the human face, or the human face may be searched through the vehicle.

Alternatively, the first target image (which may contain the human body and the vehicle) is acquired. The first target image may include the target human body picture and the target vehicle picture, one of which is a first target picture, and the the other of which is a second target picture. If the coverage of the first target picture contains the coverage of the second target picture, or the image coverage of the first target picture partially overlaps the image coverage of the second target picture, or the image coverage of the first target picture is connected with the image coverage of the second target picture, the target human body picture and the target vehicle picture in the retrieval result pictures are associated to each other.

In this case, if a first target image contains only a human body picture and a second target image contains only a vehicle picture, the human body picture may serve as a target human body picture and the vehicle picture may serve as a target vehicle picture; and the target human body picture may be associated to the target vehicle picture to obtain a complete associated image. In this way, the vehicle may be searched through the human body, or the human body may be searched through the vehicle.

According to the method described in the embodiment, through the preset spatial relationship among the human face, the human body and the vehicle, the human body may be searched through the vehicle and the vehicle may be searched through the human body, or the human body may be searched through the human face and the human face may be searched through the human body, or the human face may be searched through the vehicle and the vehicle may be found through the human face. In practical applications, with only one of the human face, the human body and the vehicle of the tracking target, the multi-dimensional information of the tracking target can still be obtained. In this case, the feasibility of this solution is further improved and the work efficiency is improved on the premise of achieving automatic association.

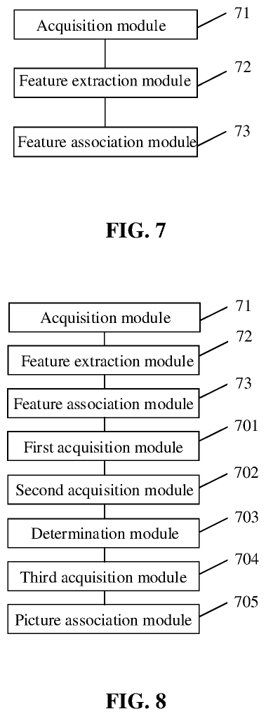

FIG. 7 illustrates a schematic structural diagram of a first embodiment of an apparatus for obtaining multi-dimensional information by picture-based integration according to the disclosure. The apparatus for obtaining multi-dimensional information by picture-based integration may be configured to perform or implement the method for obtaining multi-dimensional information by picture-based integration in any of the above embodiments. The apparatus for obtaining multi-dimensional information by picture-based integration includes an acquisition module 71, a feature extraction module 72, and a feature association module 73.

The acquisition module 71 is configured to acquire a to-be-detected picture. The feature extraction module 72 is configured to detect the to-be-detected picture and extract multiple pieces of feature information from the to-be-detected picture. The feature association module 73 is configured to select, from the multiple pieces of feature information, target feature information and associated feature information, and associate the target feature information to the associated feature information to generate multi-dimensional information. The multi-dimensional information includes multiple pieces of feature information associated with each other.

The apparatus for obtaining multi-dimensional information by picture-based integration according to the disclosure may achieve automatic extraction of multiple pieces of feature information, and automatic association and integration of multiple pieces of feature information, and can reduce manpower and improve the work efficiency in practical applications.

In some embodiments, the to-be-detected picture includes one or more to-be-detected pictures. The feature extraction module 72 is configured to: detect the one or more to-be-detected pictures, and extract the plurality of pieces of feature information from the one or more to-be-detected pictures.

In some embodiments, the feature association module 73 is further configured to: select target human face feature information corresponding to a target human face with a highest quality score in the to-be-detected picture as the target feature information, and select at least one of the following as the associated feature information: target human body feature information corresponding to the target human face feature information, or target vehicle feature information corresponding to a vehicle closest to a center point of the target human face. The feature association module 73 is further configured to: associate the target feature information to the associated feature information to generate the multi-dimensional information. The multi-dimensional information includes at least two different types of feature information of the following: the target human face feature information, the target human body feature information, or the target vehicle feature information.

In some embodiments, the feature association module 73 is further configured to: receive a control instruction, and select, based on the control instruction, the target feature information from the plurality of pieces of feature information. The target feature information is one of: the human face feature information, the human body feature information, or the vehicle feature information. The feature association module 73 is further configured to: select, according to the selected target feature information, associated feature information matching with the target feature information. The associated feature information matching with the target feature information includes at least one type of feature information of the following other than a type of the target feature information: the human face feature information, the human body feature information, or the vehicle feature information. The feature association module 73 is further configured to: associate the target feature information to the associated feature information matching with the target feature information to generate the multi-dimensional information.

In some embodiments, in response to that the selected target feature information is target human face feature information in the human face feature information, the feature association module 73 is further configured to: automatically select, according to the selected target human face feature information, at least one of the following as the associated feature information: human body feature information corresponding to the target human face feature information, or vehicle feature information corresponding to a vehicle closest to a center point of a human face associated with the target human face feature information.

Alternatively, in some embodiments, in response to that the selected target feature information is target human body feature information in the human body feature information, the feature association module 73 is further configured to: automatically select, according to the selected target human body feature information, at least one of the following as the associated feature information: human face feature information corresponding to the target human body feature information, or vehicle feature information corresponding to a vehicle closest to a center point of a human body associated with the target human body feature information.

Alternatively, in some embodiments, in response to that the selected target feature information is target vehicle feature information in the vehicle feature information, the feature association module 73 is further configured to: automatically select, according to the selected target vehicle feature information, at least one of the following as the associated feature information: human face feature information corresponding to a human face closest to a center point of a vehicle associated with the target vehicle feature information, or human body feature information corresponding to the target vehicle feature information

In some embodiments, the feature association module 73 is configured to: receive a control instruction, and select, based on the control instruction, the target feature information and the associated feature information from the plurality of pieces of feature information. The selected target feature information and the selected associated feature information include at least two different types of feature information of the following: the human face feature information, the human body feature information, or the vehicle feature information. The feature association module 73 is configured to: associate the target feature information to the associated feature information to generate the multi-dimensional information.

FIG. 8 illustrates another schematic structural diagram of a first embodiment of an apparatus for obtaining multi-dimensional information by picture-based integration according to the disclosure. The apparatus for obtaining multi-dimensional information by picture-based integration includes an acquisition module 71, a feature extraction module 72, and a feature association module 73. The details of the acquisition module 71, the feature extraction module 72, and the feature association module 73 may refer to the foregoing descriptions, and will not be described herein again. In addition, the apparatus further includes a first acquisition module 701, a second acquisition module 702, and a determination module 703.

The first acquisition module 701 is configured to retrieve a first target image from a first database based on the target feature information in the multi-dimensional information. The second acquisition module 702 is configured to retrieve a second target image from a second database based on the associated feature information in the multi-dimensional information. The determination module 703 is configured to determine the first target image and the second target image as retrieval result pictures of the to-be-detected picture.

In some embodiments, the apparatus for obtaining multi-dimensional information by picture-based integration according to the disclosure further includes a third acquisition module 704 and a picture association module 705.

Herein the third acquisition module 704 is configured to acquire at least one of the following after determining the first target image and the second target image as the retrieval result pictures of the to-be-detected picture: a target human face picture corresponding to the human face feature information, a target human body picture corresponding to the human body feature information, or a target vehicle picture corresponding to the vehicle feature information.

The picture association module 705 is configured to perform at least one of the following. In response to that the target human face picture corresponds to a same first target image as the target human body picture and has a preset spatial relationship with the target human body picture, the target human face picture and the target human body picture in the retrieval result pictures are associated to each other. In response to that the target human face picture corresponds to a same first target image as the target vehicle picture, and has a preset spatial relationship with the target vehicle picture, the target human face picture and the target vehicle picture in the retrieval result pictures are associated to each other. In response to that the target human body picture corresponds to a same first target image as the target vehicle picture and has a preset spatial relationship with the target vehicle picture, the target human body picture and the target vehicle picture in the retrieval result pictures are associated to each other.

In some embodiments, the preset spatial relationship includes at least one of: an image coverage of a first target picture contains an image coverage of a second target picture; the image coverage of the first target picture partially overlaps the image coverage of the second target picture; or the image coverage of the first target picture is connected with the image coverage of the second target picture. The first target picture includes one or more of: the target human face picture, the target human body picture, or the target vehicle picture, and the second target picture includes one or more of: the target human face picture, the target human body picture, or the target vehicle picture.

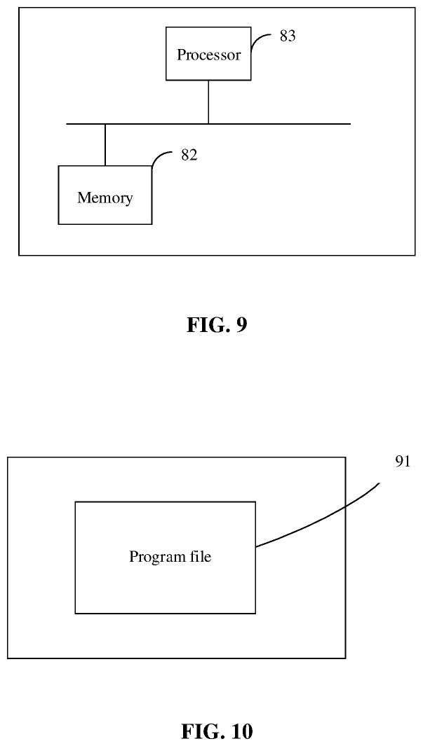

FIG. 9 illustrates a schematic structural diagram of a second embodiment of a device for obtaining multi-dimensional information by picture-based integration according to the disclosure. The device for obtaining multi-dimensional information by picture-based integration includes a memory 82 and a processor 83 connected with each other.

The memory 82 is configured to store program instructions for implementing any above method for obtaining multi-dimensional information by picture-based integration.

The processor 83 is configured to execute the program instructions stored in the memory 82.

Herein the processor 83 may also be referred to as a Central Processing Unit (CPU). The processor 83 may be an integrated circuit chip having signal processing capabilities. The processor 83 may also be a general purpose processor, a digital signal processor (DSP), an application-specific integrated circuit (ASIC), a field programmable gate array (FPGA) or another programmable logic device, a discrete gate or a transistor logic device, a discrete hardware component. The processor 83 may also be a Graphics Processing Unit (GPU) which is also known as a display core, a visual processor and a display chip, and is a microprocessor specifically responsible for image operations on a personal computer, a workstation, a game console, and some mobile devices (e.g., tablet computers, smartphones, etc.). The purpose of GPU is to convert and drive the display information required by the computer system, and provide the row scanning signal to the display to control the correct display of the display. GPU is an important component for connecting the display and the mainboard of the personal computer, and is also one of the important devices for “man-machine dialogue”. As an important component in a computer host, a graphic card performs the task of outputting a display graphic, and is very important for a person who engages in professional graphic design. The general-purpose processor may be a microprocessor or the processor may be any conventional processor, etc.

The memory 82 may be a memory bank, a Trans-Flash (TF) card, etc., and may store all information in the device for obtaining multi-dimensional information by picture-based integration, including input raw data, a computer program, an intermediate running result, and a final running result. The memory stores and retrieves information according to the location designated by the controller. With the memory, the device for obtaining multi-dimensional information by picture-based integration has a memory function to ensure normal operation. The memory in the device for obtaining multi-dimensional information by picture-based integration may be divided into a main memory (internal memory) and an auxiliary memory (external memory) by its usage, and may also be divided into an external memory and an internal memory. The external memory is usually such as a magnetic medium or an optical disc, and may store information in long term. The internal memory refers to a memory component on the mainboard, and is configured to store data and programs being executed currently, but only temporarily stores the programs and data. Data will lost when the power supply is turned off or fails.

In some embodiments provided in the disclosure, it should be understood that the disclosed device and method may be implemented in other manners. The device embodiments as described above are only schematic. For example, division of the modules or units is only division in logic functions, and other division manners may be adopted during practical implementation. For example, multiple units or components may be combined or integrated into another system, or some features may be neglected or not executed. In addition, coupling or direct coupling or communication connection between each displayed or discussed component may be indirect coupling or communication connection, implemented through some interfaces, devices or units, and may be electrical, mechanical or in other forms.

The units described as separate parts may or may not be physically separated, and parts displayed as units may or may not be physical units, that is, may be located in the same place, or may also be distributed to multiple network units. Part or all of the units may be selected to achieve the purpose of the solutions in the embodiments according to a practical requirement.

In addition, functional units in embodiments of the disclosure may be integrated into a processing unit, or each unit may be physically present separately, or two or more units may be integrated into one unit. The integrated unit may be implemented in the form of hardware or in the form of software functional units.

When implemented in the form of software functional units and sold or used as an independent product, the integrated unit may be stored in a computer-readable storage medium. Based on such an understanding, the technical solutions of the disclosure substantially or parts making contributions to the related art or part or all of the technical solutions may be embodied in form of software product. The computer software product is stored in a computer-readable storage medium, including multiple instructions configured to enable a computer device (which may be such as a personal computer, a system server or a network device) or a processor to execute all or part of the steps of the method in each embodiment of the disclosure.

FIG. 10 illustrates a schematic structural diagram of a computer-readable storage medium according to the disclosure. The computer-readable storage medium according to the disclosure stores a program file 91 capable of implementing all the above method for obtaining multi-dimensional information by picture-based integration. The program file 91 may be stored in the above computer-readable storage medium in the form of a software product, including multiple instructions configured to enable a computer device (which may be such as a personal computer, a server or a network device) or a processor to execute all or part of the steps of the method in each embodiment of the disclosure. The foregoing storage device includes various media capable of storing program codes such as a USB flash disk, a removable hard disk, a Read-Only Memory (ROM), a Random Access Memory (RAM), a magnetic disk or an optical disk, or a terminal device such as a computer, a server, a mobile phone, or a tablet.

The above are merely embodiments of the disclosure, and thus are not intended to limit the patent scope of the disclosure. Any equivalent structure or equivalent process transformation made from the contents of the description and drawings of the disclosure, or direct or indirect usage of the disclosure in other related technical fields shall fall within the patent scope of the disclosure.

What is claimed is:

1. A method for obtaining multi-dimensional information by picture-based integration, comprising:
acquiring a to-be-detected picture;
detecting the to-be-detected picture and extracting a plurality of pieces of feature information from the to-be-detected picture; and
selecting, from the plurality of pieces of feature information, target feature information and associated feature information, and associating the target feature information to the associated feature information to generate multi-dimensional information, wherein the multi-dimensional information comprises a plurality of pieces of feature information associated with each other.

2. The method of claim 1, wherein the plurality of pieces of feature information extracted comprise at least two different types of feature information of the following:
human face feature information,
human body feature information, or
vehicle feature information.

3. The method of claim 2, further comprising after selecting, from the plurality of pieces of feature information, the target feature information and the associated feature information, and associating the target feature information to the associated feature information to generate the multi-dimensional information:
retrieving a first target image from a first database based on the target feature information in the multi-dimensional information;
retrieving a second target image from a second database based on the associated feature information in the multi-dimensional information; and
determining the first target image and the second target image as retrieval result pictures of the to-be-detected picture.

4. The method of claim 1, wherein the to-be-detected picture comprises one or more to-be-detected pictures; and
detecting the to-be-detected picture and extracting the plurality of pieces of feature information from the to-be-detected picture comprises:
detecting the one or more to-be-detected pictures, and extracting the plurality of pieces of feature information from the one or more to-be-detected pictures.

5. The method of claim 2, wherein selecting, from the plurality of pieces of feature information, the target feature information and the associated feature information, and associating the target feature information to the associated feature information to generate the multi-dimensional information comprises:
selecting target human face feature information corresponding to a target human face with a highest quality score in the to-be-detected picture as the target feature information, and selecting at least one of the following as the associated feature information:
target human body feature information corresponding to the target human face feature information, or
target vehicle feature information corresponding to a vehicle closest to a center point of the target human face; and
associating the target feature information to the associated feature information to generate the multi-dimensional information, wherein the multi-dimensional information comprises at least two different types of feature information of the following:
the target human face feature information,
the target human body feature information, or
the target vehicle feature information.

6. The method of claim 2, wherein selecting, from the plurality of pieces of feature information, the target feature information and the associated feature information, and associating the target feature information to the associated feature information to generate the multi-dimensional information comprises:
receiving a control instruction, and selecting, based on the control instruction, the target feature information from the plurality of pieces of feature information, wherein the target feature information is one of: the human face feature information, the human body feature information, or the vehicle feature information;
selecting, according to the selected target feature information, associated feature information matching with the target feature information, wherein the associated feature information matching with the target feature information comprises at least one type of feature information of the following other than a type of the target feature information: the human face feature information, the human body feature information, or the vehicle feature information; and
associating the target feature information to the associated feature information matching with the target feature information to generate the multi-dimensional information.

7. The method of claim 6, wherein
in response to that the selected target feature information is target human face feature information in the human face feature information, the selecting, according to the selected target feature information, the associated feature information matching with the target feature information comprises:
automatically selecting, according to the selected target human face feature information, at least one of the following as the associated feature information: human body feature information corresponding to the target human face feature information, or vehicle feature information corresponding to a vehicle closest to a center point of a human face associated with the target human face feature information; or
in response to that the selected target feature information is target human body feature information in the human body feature information, the selecting, according to the selected target feature information, the associated feature information matching with the target feature information comprises:
automatically selecting, according to the selected target human body feature information, at least one of the following as the associated feature information: human face feature information corresponding to the target human body feature information, or vehicle feature information corresponding to a vehicle closest to a center point of a human body associated with the target human body feature information; or
in response to that the selected target feature information is target vehicle feature information in the vehicle feature information, the selecting, according to the selected target feature information, the associated feature information matching with the target feature information comprises:
automatically selecting, according to the selected target vehicle feature information, at least one of the following as the associated feature information: human face feature information corresponding to a human face closest to a center point of a vehicle associated with the target vehicle feature information, or human body feature information corresponding to the target vehicle feature information.

8. The method of claim 2, wherein selecting, from the plurality of pieces of feature information, the target feature information and the associated feature information, and associating the target feature information to the associated feature information to generate the multi-dimensional information comprises:
receiving a control instruction, and selecting, based on the control instruction, the target feature information and the associated feature information from the plurality of pieces of feature information, wherein the selected target feature information and the selected associated feature information comprise at least two different types of feature information of the following: the human face feature information, the human body feature information, or the vehicle feature information; and
associating the target feature information to the associated feature information to generate the multi-dimensional information.

9. The method of claim 3, further comprising after determining the first target image and the second target image as the retrieval result pictures of the to-be-detected picture:
acquiring at least one of the following: a target human face picture corresponding to the human face feature information, a target human body picture corresponding to the human body feature information, or a target vehicle picture corresponding to the vehicle feature information; and
performing at least one of the following:
in response to that the target human face picture corresponds to a same first target image as the target human body picture and has a preset spatial relationship with the target human body picture, associating the target human face picture and the target human body picture in the retrieval result pictures to each other;
in response to that the target human face picture corresponds to a same first target image as the target vehicle picture, and has a preset spatial relationship with the target vehicle picture, associating the target human face picture and the target vehicle picture in the retrieval result pictures to each other; or
in response to that the target human body picture corresponds to a same first target image as the target vehicle picture and has a preset spatial relationship with the target vehicle picture, associating the target human body picture and the target vehicle picture in the retrieval result pictures to each other.

10. The method of claim 9, wherein the preset spatial relationship comprises at least one of:
an image coverage of a first target picture contains an image coverage of a second target picture;
the image coverage of the first target picture partially overlaps the image coverage of the second target picture; or
the image coverage of the first target picture is connected with the image coverage of the second target picture;
wherein the first target picture comprises one or more of: the target human face picture, the target human body picture, or the target vehicle picture, and the second target picture comprises one or more of: the target human face picture, the target human body picture, or the target vehicle picture.

11. An apparatus for obtaining multi-dimensional information by picture-based integration, comprising:
a memory, and
a processor,
wherein the memory has program instructions stored thereon, and the processor calls the program instructions from the memory to:
acquire a to-be-detected picture;
detect the to-be-detected picture and extract a plurality of pieces of feature information from the to-be-detected picture; and
select, from the plurality of pieces of feature information, target feature information and associated feature information, and associate the target feature information to the associated feature information to generate multi-dimensional information, wherein the multi-dimensional information comprises a plurality of pieces of feature information associated with each other.

12. The apparatus for obtaining multi-dimensional information by picture-based integration of claim 11, the plurality of pieces of feature information extracted comprise at least two different types of feature information of the following:
human face feature information,
human body feature information, or
vehicle feature information.

13. The apparatus for obtaining multi-dimensional information by picture-based integration of claim 12, wherein after selecting, from the plurality of pieces of feature information, the target feature information and the associated feature information, and associating the target feature information to the associated feature information to generate the multi-dimensional information, the processor further calls the program instructions from the memory to :
retrieve a first target image from a first database based on the target feature information in the multi-dimensional information;
retrieve a second target image from a second database based on the associated feature information in the multi-dimensional information; and
determine the first target image and the second target image as retrieval result pictures of the to-be-detected picture.

14. The apparatus for obtaining multi-dimensional information by picture-based integration of claim 11, wherein the to-be-detected picture comprises one or more to-be-detected pictures; and
in detecting the to-be-detected picture and extracting the plurality of pieces of feature information from the to-be-detected picture, the processor calls the program instructions from the memory to:
detect the one or more to-be-detected pictures, and extract the plurality of pieces of feature information from the one or more to-be-detected pictures.

15. The apparatus for obtaining multi-dimensional information by picture-based integration of claim 12, wherein in selecting, from the plurality of pieces of feature information, the target feature information and the associated feature information, and associating the target feature information to the associated feature information to generate the multi-dimensional information, the processor calls the program instructions from the memory to :
select target human face feature information corresponding to a target human face with a highest quality score in the to-be-detected picture as the target feature information, and select at least one of the following as the associated feature information:
target human body feature information corresponding to the target human face feature information, or
target vehicle feature information corresponding to a vehicle closest to a center point of the target human face; and
associate the target feature information to the associated feature information to generate the multi-dimensional information, wherein the multi-dimensional information comprises at least two different types of feature information of the following:
the target human face feature information,
the target human body feature information, or
the target vehicle feature information.

16. The apparatus for obtaining multi-dimensional information by picture-based integration of claim 12, wherein in selecting, from the plurality of pieces of feature information, the target feature information and the associated feature information, and associating the target feature information to the associated feature information to generate the multi-dimensional information, the processor calls the program instructions from the memory to:
receive a control instruction, and select, based on the control instruction, the target feature information from the plurality of pieces of feature information, wherein the target feature information is one of: the human face feature information, the human body feature information, or the vehicle feature information;
select, according to the selected target feature information, associated feature information matching with the target feature information, wherein the associated feature information matching with the target feature information comprises at least one type of feature information of the following other than a type of the target feature information: the human face feature information, the human body feature information, or the vehicle feature information; and
associate the target feature information to the associated feature information matching with the target feature information to generate the multi-dimensional information.

17. The apparatus for obtaining multi-dimensional information by picture-based integration of claim 16, wherein:
in response to that the selected target feature information is target human face feature information in the human face feature information, in the selecting, according to the selected target feature information, the associated feature information matching with the target feature information, the processor calls the program instructions from the memory to:
automatically select, according to the selected target human face feature information, at least one of the following as the associated feature information: human body feature information corresponding to the target human face feature information, or vehicle feature information corresponding to a vehicle closest to a center point of a human face associated with the target human face feature information; or
in response to that the selected target feature information is target human body feature information in the human body feature information, in the selecting, according to the selected target feature information, the associated feature information matching with the target feature information, the processor calls the program instructions from the memory to:
automatically select, according to the selected target human body feature information, at least one of the following as the associated feature information: human face feature information corresponding to the target human body feature information, or vehicle feature information corresponding to a vehicle closest to a center point of a human body associated with the target human body feature information; or
in response to that the selected target feature information is target vehicle feature information in the vehicle feature information, the selecting, according to the selected target feature information, the associated feature information matching with the target feature information, the processor calls the program instructions from the memory to:
automatically select, according to the selected target vehicle feature information, at least one of the following as the associated feature information: human face feature information corresponding to a human face closest to a center point of a vehicle associated with the target vehicle feature information, or human body feature information corresponding to the target vehicle feature information.

18. The apparatus for obtaining multi-dimensional information by picture-based integration of claim 12, wherein in selecting, from the plurality of pieces of feature information, the target feature information and the associated feature information, and associating the target feature information to the associated feature information to generate the multi-dimensional information, the processor calls the program instructions from the memory to:
receive a control instruction, and select, based on the control instruction, the target feature information and the associated feature information from the plurality of pieces of feature information, wherein the selected target feature information and the selected associated feature information comprise at least two different types of feature information of the following: the human face feature information, the human body feature information, or the vehicle feature information; and
associate the target feature information to the associated feature information to generate the multi-dimensional information.

19. The apparatus for obtaining multi-dimensional information by picture-based integration of claim 13, after determining the first target image and the second target image as the retrieval result pictures of the to-be-detected picture, the processor calls the program instructions from the memory to:
acquire at least one of the following after determining the first target image and the second target image as the retrieval result pictures of the to-be-detected picture: a target human face picture corresponding to the human face feature information, a target human body picture corresponding to the human body feature information, or a target vehicle picture corresponding to the vehicle feature information; and
perform at least one of the following:
in response to that the target human face picture corresponds to a same first target image as the target human body picture and has a preset spatial relationship with the target human body picture, associating the target human face picture and the target human body picture in the retrieval result pictures to each other;
in response to that the target human face picture corresponds to a same first target image as the target vehicle picture, and has a preset spatial relationship with the target vehicle picture, associating the target human face picture and the target vehicle picture in the retrieval result pictures to each other; or
in response to that the target human body picture corresponds to a same first target image as the target vehicle picture and has a preset spatial relationship with the target vehicle picture, associating the target human body picture and the target vehicle picture in the retrieval result pictures to each other.

20. A non-transitory computer-readable storage medium having stored thereon a program file which is executable to implement a method for obtaining multi-dimensional information by picture-based integration, the method comprising:
acquiring a to-be-detected picture;
detecting the to-be-detected picture and extracting a plurality of pieces of feature information from the to-be-detected picture; and
selecting, from the plurality of pieces of feature information, target feature information and associated feature information, and associating the target feature information to the associated feature information to generate multi-dimensional information, wherein the multi-dimensional information comprises a plurality of pieces of feature information associated with each other.
